(19) United States
(12) Patent Application Publication
(10) Pub. No.: US 2016/0078595 A1
(43) Pub. Date: Mar. 17, 2016

(54) OBJECT OPERATION SYSTEM, NON-TRANSITORY COMPUTER-READABLE STORAGE MEDIUM STORING OBJECT OPERATION CONTROL PROGRAM, AND OBJECT OPERATION CONTROL METHOD

(71) Applicant: Konica Minolta, Inc., Tokyo (JP)

(72) Inventors: Shinya OGINO, Tokyo (JP); Shunsuke TAKAMURA, Tokyo (JP); Kazuma TAKEUCHI, Tokyo (JP); Ikuko TSUBOTANI, Tokyo (JP); Noriko HOSHINO, Tokyo (JP); Kagumi MORIWAKI, Kawanishi-shi (JP); Yoichi KAWABUCHI, Itami-shi (JP)

(73) Assignee: Konica Minolta, Inc., Tokyo (JP)

(21) Appl. No.: 14/853,153

(22) Filed: Sep. 14, 2015

(30) Foreign Application Priority Data
Sep. 16, 2014 (JP) 2014-187254

(51) Int. Cl. G06T 3/40; G06T 11/60; G06F 3/0488; G06F 3/0484; G06F 3/0481

(52) U.S. Cl. CPC G06T 3/40; G06F 3/04845; G06F 3/04817; G06F 3/0488; G06T 11/60

(57) ABSTRACT

An object operation system includes a display section which can display objects thereon, an operation section which allows a user to operate an object displayed on the display section, and a control section which controls the display section and the operation section. The control section calculates display sizes of a plurality of objects displayed on the display section as operation targets, calculates statistic information about the display sizes, and determines whether the statistic information meets a criterion defined in advance. On determining that the statistic information does not meet the criterion, the control section prevents a specific operation performed through the operation section on at least one of the plurality of objects.

The entire disclosure of Japanese Patent Application No. 2014-187254 filed on Sep. 16, 2014 including description, claims, drawings, and abstract are incorporated herein by reference in its entirety.

### TECHNICAL FIELD

The present invention relates to an object operation system, a non-transitory computer-readable storage medium storing an object operation control program and an object operation control method. Particularly, the present invention relates to an object operation system which controls whether to accept or prevent user's operations on plural objects; a non-transitory computer-readable storage medium storing an object operation control program for causing an apparatus to perform the control; and an object operation control method for use in such a system.

### BACKGROUND

In recent years, electronic meetings are popularly held. In an electronic meeting, a display screen (referred to as a common screen) which can be used by plural users is employed and users have a discussion while inputting various display elements (hereinafter, referred to as objects), such as characters, figures and images, by a pen or a user's finger on the common screen. Such a common screen uses an application and allows users to discuss while moving an object to a desired place and/or editing an object on the common screen.

### DESCRIPTION OF THE RELATED ART

A system for use in such an electronic meeting can cause the situation that, in response to a user's operation on an object with the intention of moving an object, the system determines that the operation is an operation to edit the object and then the object is actually edited. In view of the problem, a system disclosed in Japanese Unexamined Patent Publication (JP-A) No. 2012-104095 (corresponding to US2012/0092355A1) performs the following control. If an object as an operation target is displayed in small size on the screen, the system scrolls the screen in response to a user's operation. If an object as an operation target is displayed with being enlarged on the screen, the system allows a user to write within the object in response to a user's operation.

As a way to operate an object in such a system, the following ways can be considered. The first way is that a system is configured to allow a user to switch an operation mode in advance, and a user changes the operation mode to the desired mode and then operates an object. The second way is that a system is configured to check the number of user's fingers performing an operation, and a user performs different operations in accordance with the number of the fingers.

However, the first way needs a user to change the operation mode, which can make user's operations complicated. Further, if a user erroneously changed the operation mode to an unwanted mode, a succeeding operation can make an unintended result. The second way needs a user to learn the way to operate objects on the system. Further, if a user performed an erroneous operation, such an operation can make an unintended result.

In another way that, as disclosed in JP-A No. 2012-104095, a system changes possible operations to be performed on objects depending on the object size, under the condition that plural objects are displayed on a screen of the system, the possible operations are defined separately for each object. It can cause the situation that a user's operation results in unintended processing, when a user is going to operate plural objects which are similar in size and includes objects of different sizes such that the threshold for switching the possible operations of objects falls between the sizes. For example, in response to a user's operation, one of the plural objects can be edited but another object cannot be edited. Such a situation can confuse the user.

The present invention seeks to solve the problems.

### SUMMARY

Aspects of the present inventions are directed to object operation systems, non-transitory computer-readable storage media each storing an object operation control program and object operation control methods, whereby, under the condition that plural objects as operation targets are displayed on a display screen, a user can operate the plural objects properly and equally.

An illustrative object operation system reflecting one aspect of the present invention is an object operation system comprising: a display section which can display objects thereon; an operation section which allows a user to operate an object displayed on the display section; and a control section which controls the display section and the operation section. The control section calculates display sizes of a plurality of objects displayed on the display section, calculates statistic information about the display sizes, and determines whether the statistic information meets a criterion defined in advance. On determining that the statistic information does not meet the criterion, the control section prevents a specific operation performed through the operation section on at least one of the plurality of objects.

An illustrative non-transitory computer-readable storage medium reflecting one aspect of the present invention stores an object operation control program to be executed in an apparatus. The apparatus controls a display section which can display objects thereon and an operation section which allows a user to operate an object displayed on the display section. The object operation control program, when being executed by a processor of the apparatus, causes the apparatus to perform processing comprising: calculating display sizes of a plurality of objects displayed on the display section; calculating statistic information about the display sizes; and determining whether the statistic information meets a criterion defined in advance. The processing further comprises, on determining that the statistic information does not meet the criterion, preventing a specific operation performed through the operation section on at least one of the plurality of objects.

An illustrative object operation method reflecting one aspect of the present invention is an object operation control method for use in a system including a display section which can display objects thereon and an operation section which allows a user to operate an object displayed on the display section. The method comprises: calculating display sizes of a plurality of objects displayed on the display section; calculating statistic information about the display sizes; and determining whether the statistic information meets a criterion defined in advance. The method further comprises, on determining that the statistic information does not meet the criterion, preventing a specific operation performed through the operation section on at least one of the plurality of objects.

Other features of illustrative embodiments will be described below.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, and wherein:

FIG. 1 is a diagram schematically illustrating the structure of an object operation system relating to an embodiment of the present invention;

FIG. 2 is a diagram schematically illustrating another structure of an object operation system relating to an embodiment of the present invention;

FIG. 3 is a diagram schematically illustrating another structure of an object operation system relating to an embodiment of the present invention;

FIG. 4 is a diagram schematically illustrating another structure of an object operation system relating to an embodiment of the present invention;

FIGS. 5A and 5B are block diagrams schematically illustrating the structure of an object operation system relating to an embodiment of the present invention;

FIG. 6 is a flowchart illustrating an example of operation (processing to determine operation prevention) of the object operation system relating to an embodiment of the present invention;

FIG. 7 is a flowchart illustrating an example of operation (processing of object operation) of the object operation system relating to an embodiment of the present invention;

FIG. 8 is a flowchart illustrating an example of operation (processing to determine operation prevention in accordance with a kind of operation) of the object operation system relating to an embodiment of the present invention;

FIG. 9 is a flowchart illustrating another example of operation (processing to determine operation prevention) of the object operation system relating to an embodiment of the present invention;

FIG. 10 is a diagram illustrating an example of a display screen of the object operation system relating to an embodiment of the present invention;

FIG. 11 is a diagram illustrating an example of an operation related to editing (writing) of an object, in the object operation system relating to an embodiment of the present invention;

FIG. 12 is a diagram illustrating an example of an operation related to arrangement (movement) of an object, in the object operation system relating to an embodiment of the present invention;

FIG. 13 is a diagram illustrating an example of a way to display operation mode buttons for an object, in the object operation system relating to an embodiment of the present invention;

FIG. 14 is a diagram illustrating another example of a way to display operation mode buttons for an object, in the object operation system relating to an embodiment of the present invention;

FIGS. 15A and 15B are diagrams illustrating an example of an object operation control method (an operation to move an object under the condition that the ratio is greater than the threshold) relating to an embodiment of the present invention;

FIGS. 16A and 16B are diagrams illustrating an example of an object operation control method (an operation to edit an object under the condition that the ratio is greater than the threshold) relating to an embodiment of the present invention;

FIGS. 17A and 17B are diagrams illustrating an example of an object operation control method (an operation to edit an object under the condition that the ratio is not greater than the threshold) relating to an embodiment of the present invention;

FIGS. 18A and 18B are diagrams illustrating examples of a way to indicate that an editing operation on an object is accepted, in the object operation system relating to an embodiment of the present invention;

FIGS. 19A and 19B are diagrams illustrating examples of a way to inform that an editing operation on an object is prevented, in the object operation system relating to an embodiment of the present invention;

FIGS. 20A and 20B are diagrams illustrating an example of an object operation control method (an operation to move an object under the condition that the ratio is greater than the threshold and all the objects are greater than a predetermined size) relating to an embodiment of the present invention;

FIGS. 21A and 21B are diagrams illustrating an example of an object operation control method (an operation to edit an object under the condition that the ratio is greater than the threshold and all the objects are greater than a predetermined size) relating to an embodiment of the present invention; and

FIGS. 22A and 22B are diagrams illustrating an example of an object operation control method (an operation to edit an object under the condition that the ratio is not greater than the threshold and any of the objects is not greater than the predetermined size) relating to an embodiment of the present invention.

### DESCRIPTION OF THE PREFERRED EMBODIMENTS

Hereinafter, an embodiment of the present invention will be described with reference to the drawings. However, the scope of the invention is not limited to the illustrated examples.

Possible operations to be performed by a user on objects displayed on a display screen of an object operation (electric meeting) system can be roughly classified into two groups: operations to change the arrangement of an object without changing its contents (referred to as operations related to arrangement), such as moving, rotating, flipping, enlarging and reducing an object; and operations to change the contents of an object (referred to as operations related to editing), such as a modification of the contents of an object.

As a way to allow a user to perform these operations properly, the way to switch an object operation mode in an object operation (electric meeting) system can be considered. However, this way needs a user to switch the operation mode, which can make user's operations complicated. Further, if a user erroneously changed the operation mode to an unwanted mode, a succeeding operation can make an unintended result. Alternatively, the way to perform a different operation on an object according to the number of user's fingers performing the operation, can be considered. However, the second way needs a user to learn the way to operate objects on the system and makes user's intuitive operations difficult. Further, if a user performed an erroneous operation, such an operation can make an unintended result. Further, in another way that a system changes possible operations to be performed on objects depending on the object size, as disclosed in JP-A No. 2012-104095, possible operations are changed for each object, even if the contents of the objects as operation targets are similar. Therefore, it can cause the situation that a user's operation results in unintended processing.

Under the situation that users are discussing by using a group of objects displayed on a display screen of an object operation (electronic meeting) system, it can be considered that the group of objects are displayed with being enlarged on the display screen during the discussion, for the purpose of keeping the objects easy to see for the users. Accordingly, it is reasonable that the system is configured to allow the users to operate all the group of objects without any limitations, when the ratio of objects of large display size on the display screen is relatively great. On the other hand, if the group of objects are not used in the discussion, it can be considered that the group of objects are displayed with being reduced in size on the display screen, for the purpose of preventing the objects from making the visibility of other objects worse. Accordingly, it is reasonable that the system is configured to protect all the objects needed to be protected among the group of objects from users' operations, when the ratio of objects of large display size on the display screen is relatively small, for the purpose of preventing the objects from being operated erroneously before it happens, and of avoiding a unwanted record being kept in the image obtained after the entire discussion.

As described above, it is considered that acceptable operations on a group of objects on a display screen depend on the value of the ratio of objects of large display size among the group of objects. In view of that, in place of defining operations which are acceptable for each object independently in accordance with the display size of the each object, an object operation system as an embodiment of the present invention defines operations which are acceptable for all the necessary objects among objects as operation targets, on the basis of statistic information. The statistic information is calculated by the display sizes of the objects as operation targets, for example, the ratio of objects of large display size among the objects as the operation targets. That is, the object operation system is configured to perform the control to calculate display sizes of plural objects as operation targets on the display screen, calculate statistic information about the display sizes, determine whether the statistic information meets a criterion defined in advance, and on determining that the statistic information does not meet the criterion, prevent a specific operation performed on at least one of the plural objects.

For example, the object operation system is configured to perform the following control. The object operation system calculates the display sizes (for example, areas, heights or widths) of plural objects as operation targets, compares each data size and a first threshold defined in advance, and calculates the ratio of objects of display size being greater than the first threshold among the plural objects as operation targets. If the ratio is not greater than a second threshold defined in advance (the ratio is equal to or less than the second threshold), the object operation system prevents a specific operation performed on at least an object of display size being not greater than (being equal to or less than) the first threshold among the plural objects as the operation targets, in other words, the object operation system protects at least an object of display size being not greater than the first threshold among the plural objects as the operation targets from a specific operation. In concrete terms, if the ratio is greater than the second threshold, the object operation system accepts both of an operation related to arrangement performed on an object among all the objects as operation targets and an operation related to editing performed on an object among all the objects as operation targets; and if the ratio is not greater than the second threshold, the object operation system accepts an operation related to arrangement performed on an object among all the objects as the operation targets but prevents an operation related to editing of at least an object of display size being not greater than the first threshold among the plural objects as the operation targets.

By employing this control, an object control system allows users who are discussing while operating objects displayed on the system to operate the objects easily as they intend, and the users can conduct the discussion efficiently. Further, by employing the control, the system can avoid unwanted operations so as to make an unintended record of the discussion, before they happen, which can prevent deterioration of the quality of the image obtained after the entire discussion.

### Examples

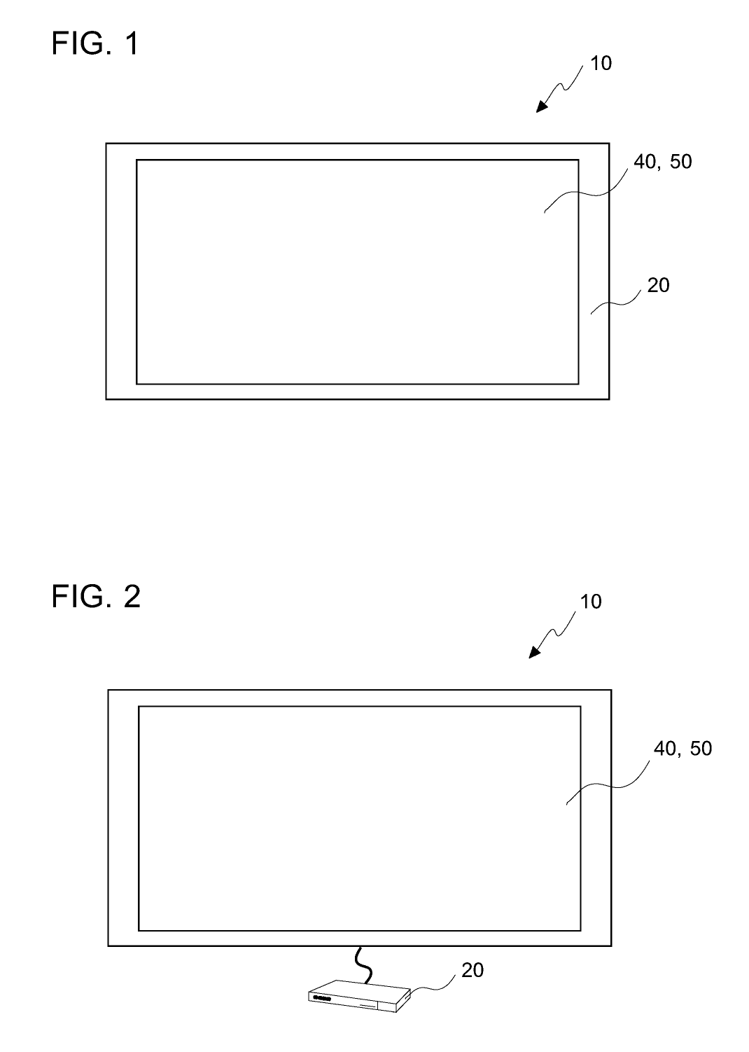

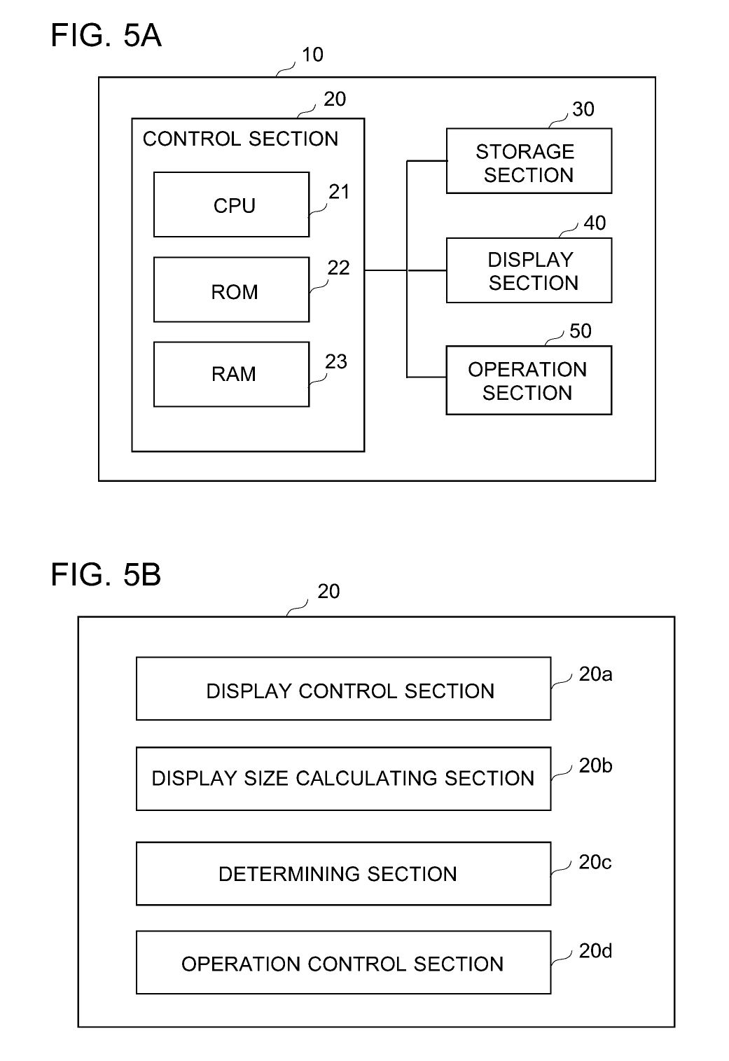

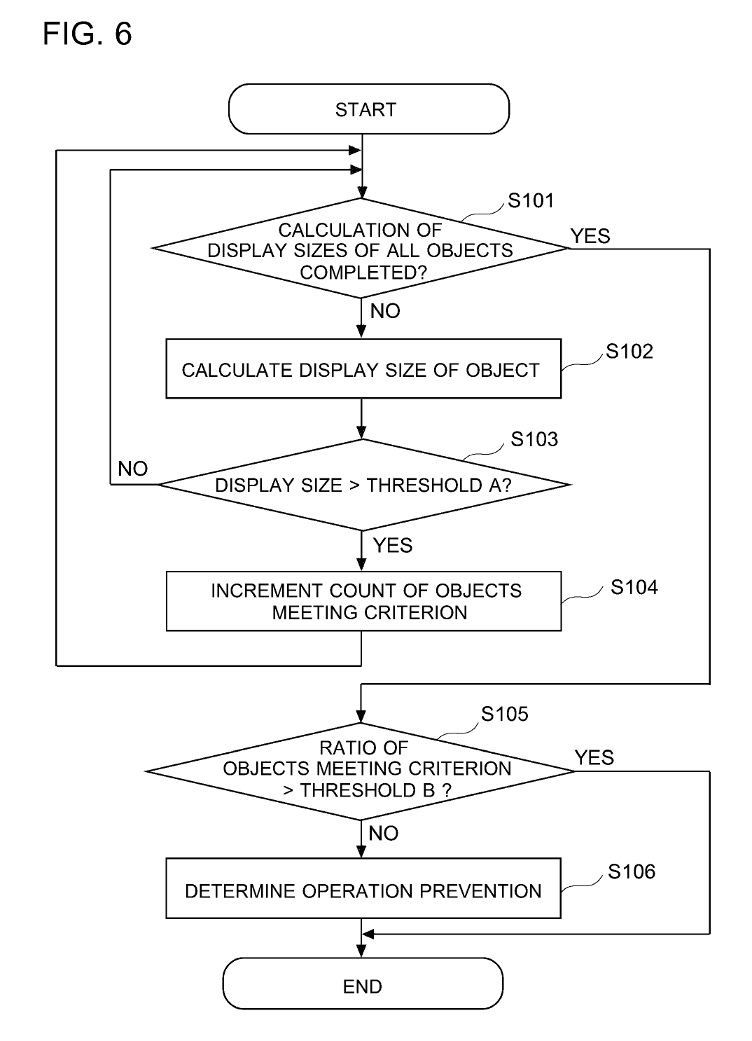

An illustrative object operation system, non-transitory computer-readable storage medium storing an object operation control program, and object operation control method will be described with reference to FIGS. 1 to 22B so as to describe the above-described embodiments in detail. Each of FIGS. 1 to 4 is a diagram schematically illustrating the structure of an object operation system of the present example, and FIGS. 5A and 5B are block diagrams schematically illustrating the structure of an object operation system of the present example. Each of FIGS. 6 to 9 is a flowchart illustrating an example of operation of the object operation system of the present example. FIGS. 10 to 22B are diagrams for illustrating a control method of an operation performed on an object.

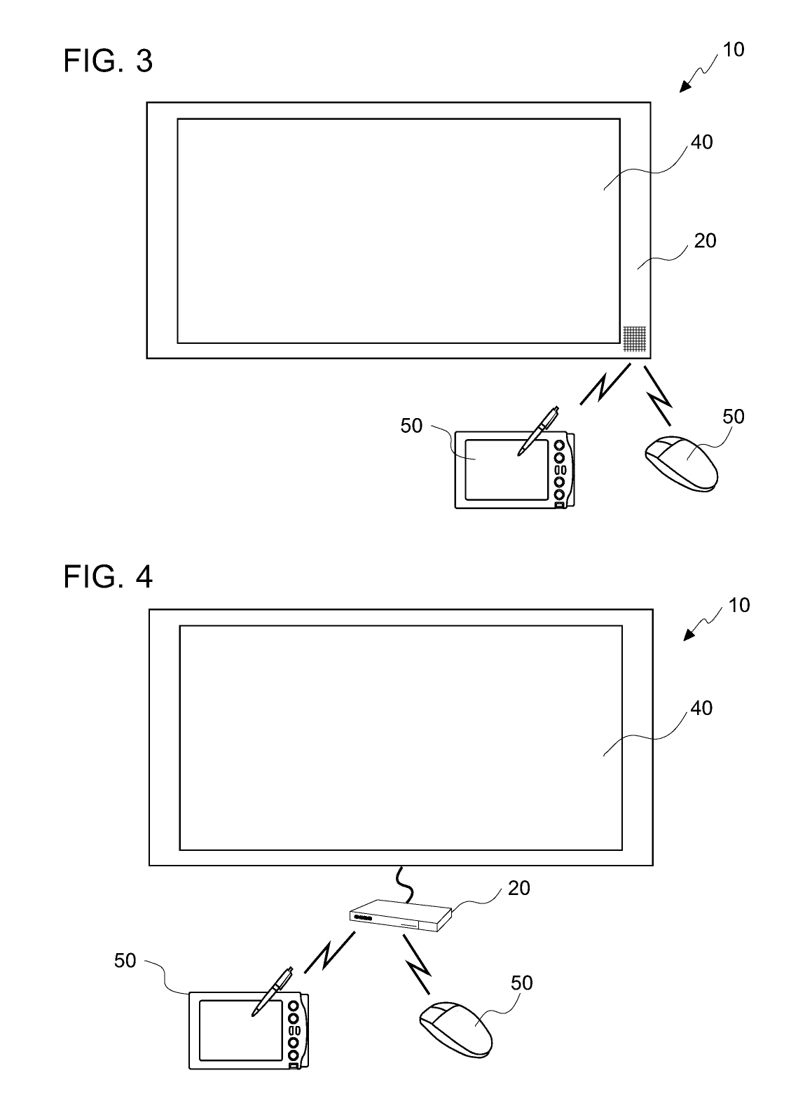

The present example can be applied to both of a system used by one operator and a system used by are plural operators, but the following description is given to a system including a common working area which allows operations of plural users, for an explanation purpose. The four possible basic structures of the object operation system can be considered as follows. The first is, as illustrated in FIG. 1, object operation system 10 including an apparatus which is equipped with a touch screen and control section 20 and provided as one body. The touch screen includes display section 40 which displays objects and operation section 50 which allows users to operate an object on the display section 40, and the control section 20 controls display section 40 and operation section 50. The second is, as illustrated in FIG. 2, object operation system 10 including a touch screen and control section 20 which are provided as separated bodies. The touch screen includes display section 40 and operation section 50. The touch screen and control section 20 are communicable by using wire or wireless communications, and the control section 20 controls the display section 40 and the operation section 50. The third is, as illustrated in FIG. 3, object operation system 10 including an apparatus which is equipped with display section 40 and control section 20 and provided as one body, and further including operation sections 50. The apparatus and the operation sections 50 are provided as separated bodies, but operation sections 50 can send operation signals to control section 20 by using wire or wireless communications. The fourth is, as illustrated in FIG. 4, object operation system 10 including display section 40, operation sections 50 and control section 20 which are provided as separated bodies but communicable by using wire or wireless communications. In the following description is given to the first structure illustrated in FIG. 1, for the purpose of making the description simple.

Object operation system 10 of the present example may include a sub-device which is communicable with components of the object operation system by using wire or wireless communications. The sub-device can be provided as a display panel with computing function, an electronic blackboard (or whiteboard), a computing device such as a personal computer, and a tablet terminal. Object operation system 10 of the present example includes control section 20, storage section 30, display section 40 and operation section, as illustrated in FIG. 5A.

Control section 20 includes CPU (Central Processing Unit) 21 and storages including ROM (Read Only Memory) 22 and RAM (Random Access Memory) 23. CPU 21 reads control programs from ROM 22 or storage section 30, loads the control programs onto RAM 23, and executes the control programs, thereby performing the whole control of the object operation system 10. As illustrated in FIG. 5B, control section 20 also works as display control section 20a, display size calculating section 20b, determining section 20c and operation control section 20d.

Display control section 20a causes display section 40 to display objects according to user's operations performed through operating section 50, and sends information (coordinates and other positional information) of the displayed position of each object to display size calculating section 20b.

Display size calculating section 20b calculates the display size (such as an area occupied by an object, a height and a width) of each of plural objects as operation targets on display section 40, where the plural objects as operation targets can be, for example, all the objects displayed on display section 40, plural objects displayed in a certain area on display section 40, or plural objects made into one group in advance. The area of an object can be, for example, a size of an area occupied or covered by an object itself, or a size of an area occupied or covered by a rectangle surrounding an object. The area can be calculated on the basis of information of a displayed position of each object sent from display control section 20a. The length such as a height and width of an object can be a length of a rectangle surrounding an object, measured in the height or width direction (the longer or shorter one out of the length in the height direction and the length in the width direction of the rectangle). The length can be calculated also on the basis of information of a displayed position of each object sent from display control section 20a.

Determining section 20c calculates statistic information by using the display sizes calculated for the respective objects. For example, determining section 20c compares each of the calculated display sizes with a predetermined threshold about size (hereinafter, referred to as threshold A), and calculates the ratio of objects of display size being greater than threshold A among all the objects as operation targets. Determining section 20c may further calculate an average and a standard deviation of the calculated display sizes, and a difference of the maximum and the minimum of the calculated display sizes. Then, determining section 20c compares the calculated statistic information (hereinafter, assumed to be the ratio of objects of display size being greater than threshold A among all the objects as operation targets) with a predetermined threshold about ratio (hereinafter, referred to as threshold B). Then, the determining section 20c determines whether the ratio is greater than threshold B or not greater than threshold B, in the other words, the determining section 20c defines a criterion that the ratio is greater than threshold B and determines whether the statistic information meets the criterion. After that, the determining section 20c sends a determined result to operation control section 20d.

The determining section 20c may define the value of threshold A appropriately according to the kind of operation, the kind of object, the screen size of display section 40, the size of handwriting information, the kind of operating unit used to create an object. For example, possible operations to be performed on an object include an operation to edit an object, an operation to move an object, an operation to enlarge or reduce an object, and an operation to rotate or flip an object. Among them, an operation to edit an object (for example, modifying the contents of the object like handwriting information) and an operation to enlarge or reduce an object make a change of the display size of the object. Therefore, the determining section 20c may change the value of threshold A according to the kind of operation performed on an object (for example, a large value is set at threshold A in the case of an operation to edit an object or an operation to enlarge an object, and a small value is set at threshold A in the case of an operation to reduce an object). As for the kind of object, the value of threshold A defined when a text object is operated may be made greater than the value defined when a graphic object or an image object is operated, because users desire to recognize every character in a text object on operating the object and desire to recognize the entire of an graphic or image object on operating the object. As for the screen size, it can be considered that users tend to draw or write objects of small size if display section 40 has a small-sized screen, and tend to draw or write objects of large size if display section 40 has a large-sized screen. Therefore, the value of threshold A may be defined according to the screen size (for example, the value of threshold A in the case of the large-sized screen is made greater than that in the case of the small-sized screen). As for handwriting information (specifically, characters), the value of threshold A may be defined on the basis of a reference size (typical size or average size) of handwriting information, because most of users write or draw handwriting information (specifically, characters) of user's own size. For example, the value of threshold A in the case that handwriting information of large reference size is operated may be made greater than that in the case that handwriting information of small standard size is operated. As for the kind of operation unit, the value of threshold A may be defined according to the kind of operating unit, because the object size differs between when a user creates an object with a pointing device such as a pen and a mouse, which exhibits high resolution, and when a user creates an object with the user's finger. For example, the value of threshold A in the case of an object written or drawn by a user's finger may be made greater than that in the case of an object written or drawn by a pointing device with high resolution.

Further, the determining section 20c may define the value of threshold B appropriately according to the kind of object, the number of objects, elapsed display time, a user of object operating system 10, and the number of participants. As for the kind of object, the value of threshold B in the case of a text object may be made smaller than that in the case of a graphic object or an image object, because most of uses write text objects in almost the same size but draw graphic objects and image objects in various sizes. Further, in the case that the number of objects is small or the elapsed display time of objects, for which objects are kept displayed, is short, the value of threshold B may be made smaller, because the sizes of the objects can be greatly different and the fluctuation of the above-described ratio can increase in such a case. Further, the value of threshold B may be defined according to a user of the system, because the sizes of objects depend on users who create the objects, for example, one user may draw objects in similar size and another user may draw objects in various sizes. Further, the value of threshold B may be defined according to the number of participants, because objects tend to be in the same size in a meeting with the small number of participants and objects tend to be in various sizes in a meeting with the increased number of participants.

Operation control section 20d defines acceptable operations which can be performed on all the objects as operation targets, in accordance with the determination result sent from determining section 20c, and controls user's operations according to the definition. In other words, if the above-described ratio is not greater than threshold B (the statistic information does not meet the criterion), the operation control section 20d prevents a specific operation performed on at least an object of display size being not greater than threshold A (at least one of the plural objects as operation targets) among the plural objects as operation targets. In concrete terms, under the assumption that the possible operations on objects are operations related to arrangement and operations related to editing, operation control section 20d performs the following control. If the ratio is greater than threshold B, operation control section 20d accepts an operation related to arrangement performed on any of all the object as operation targets and an operation related to editing performed on any of all the objects, because there is a high probability that users perform various operations on all the objects. If the ratio is not greater than (is equal to or less than) threshold B, operation control section 20d accepts an operation related to arrangement performed on any of all the objects as operation targets, but prevents an operation related to editing performed on any of all the objects as operation targets or on any of all the objects of display size being not greater than threshold A, because there is a low probability that users edit the objects. Further, operation control section 20d may define the kind of operation performed on an object on the display screen, on the basis of signals output by operation section 50, and if the ratio is not greater than threshold B and the defined kind of operation is an operation related to editing, operation control section 20d may prevent the operation related to editing. Further, on the basis of the kind of operation which was defined, the operation control section 20d causes the display section 40 to display information indicating whether the operation is an accepted operation or a prevented operation (corresponding to operation mode buttons which will be described later) in an active mode or grayed-out mode so that users can distinguish the accepted operation and the prevented operation. Further, when preventing an operation related to editing, operation control section 20d informs users about the prevention of the operation by displaying a figure indicating the prevention (a cross sign which will be described later) on the operation mode button, or by displaying a warning message that the operation is prevented.

The display control section 20a, display size calculating section 20b, determining section 20c and operation control section 20d may be provided as hardware devices. Alternatively, the display control section 20a, display size calculating section 20b, determining section 20c and operation control section 20d (specifically, display size calculating section 20b, determining section 20c and operation control section 20d) may be provided by a software (object operation control program) which causes the control section 20 to function as these sections when being executed. That is, the control section 20 may be configured to serve as the display control section 20a, display size calculating section 20b, determining section 20c and operation control section 20d (specifically, display size calculating section 20b, determining section 20c and operation control section 20d), when CPU 21 executes the object operation control program.

Storage section 30 includes a component, such as a memory, HDD (Hard Disk Drive) and SSD (Solid State Drive), and stores data such as contents of operations performed through operation section 50, information of objects displayed on display section 40, information of display sizes of objects, thresholds, and a count value of objects which meet the criterion.

Display section 40 includes a display such as a LCD (Liquid Crystal Display) and organic EL (Electro-Luminescence) display, and offers a working area which allows a user or users to operate objects thereon (in the case that the system employs a common screen, a common working area which allows plural users to operate objects thereon). Operation section 50 includes a device such as a touch sensor including electrodes arranged in a lattice shape on display section 40, hardware keys, a keyboard, and a mouse, and receives various operations performed on objects and outputs signals corresponding to the operations to control section 20.

Hereinafter, description is given to an object operation control method using object operation system 10 which employs the above structure. CPU 21 loads an object operation control program stored in ROM 22 or storage section 30 and executes the object operation control program, to cause the control section to perform processing of the steps shown in flowcharts of FIG. 6 to FIG. 9. The following description is given under the assumption that plural objects are displayed on display section 40 in advance. CPU 21 may perform other processing than the processing of the object operation control program, but the description of processing which is not directly related to the object operation control program is omitted for the purpose of avoiding lengthy description. Processing to Determine Operation Prevention:

As illustrated in FIG. 6, control section 20 (display size calculating section 20b) determines whether calculation of display sizes of plural objects as operation targets has been completed (S101), where the plural objects as operation targets are, for example, all the objects displayed on display section 40, plural objects displayed in a certain area of display section 40, or plural objects made in one group in advance. When there is an object of which the display size is not calculated (NO in S101), control section 20 (display size calculating section 20b) calculates the display size (such as occupied area, height, and width) of the object, on the basis of information of the displayed position of the object sent from display control section 20a (S102).

Next, control section 20 (determining section 20c) compares the display size calculated in S102 with threshold A which was defined in advance (S103). If the display size is not greater than (equal to or less than) threshold A (NO in S103), the flow returns to S101 and repeats similar processing. If the display size is greater than threshold A (YES in S103), control section 20 (determining section 20c) increments the count of objects meeting the criterion by 1 (S104), and then, the flow returns to S101.

When calculation of the display sizes of all the objects as operation targets has been completed (YES in S101), control section 20 (determining section 20c) calculates the ratio of the count value of objects meeting the criterion relative to the number of the plural objects of which the display sizes have been calculated (in other words, the ratio of objects of display size being greater than threshold A among the plural objects as operation targets). Then, control section 20 (determining section 20c) compares the ratio of objects meeting the criterion with threshold B which was defined in advance (S105). If the ratio of objects meeting the criterion is greater than threshold B (YES in S105), the processing is ended. If the ratio of objects meeting the criterion is not greater than threshold B (NO in S105), control section 20 (determining section 20c) determines to prevent a specific operation or operations (for example, operations related to editing) from which objects are to be protected (S106). In concrete terms, control section 20 (operation control section 20d) establishes a flag indicating the kind of operation to be prevented and indicating that the operation is prevented.

### Processing of Object Operation:

In response to receiving a user's operation performed on an object through operation section 50 after the processing to determine operation prevention, the control section 20 performs the processing of object operation. For the purpose of easy understanding of the processing, the following description is given under the assumption that an operation performed on an object is an operation related to editing or an operation related to arrangement.

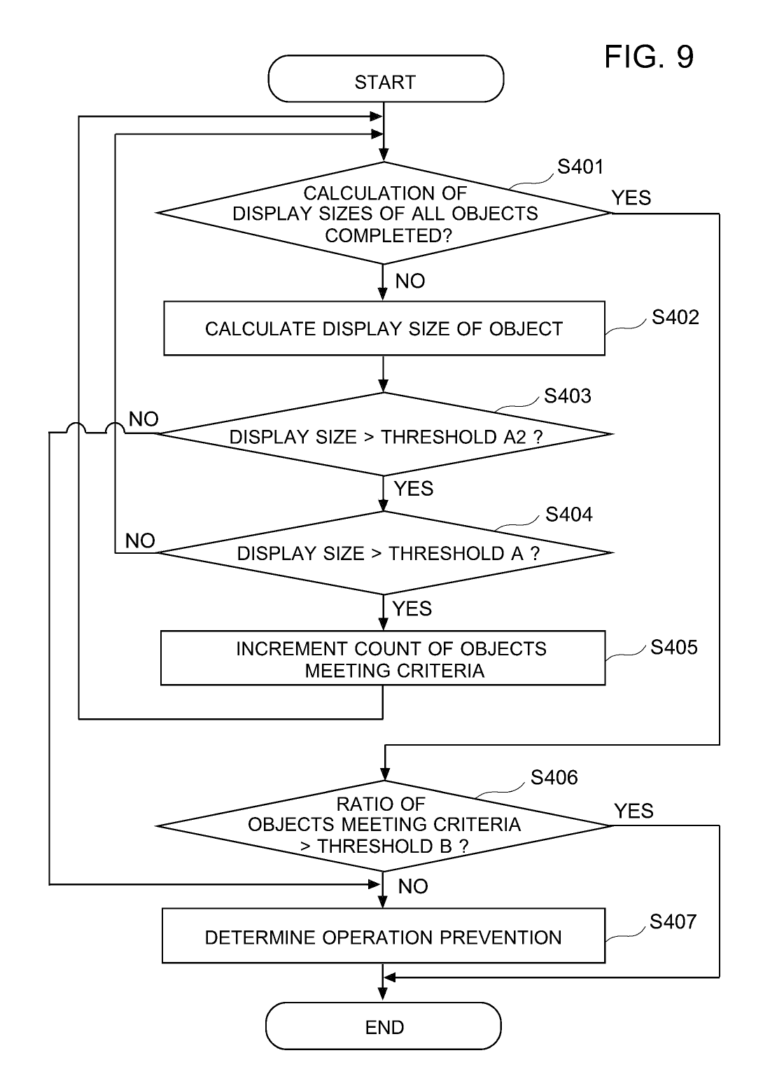

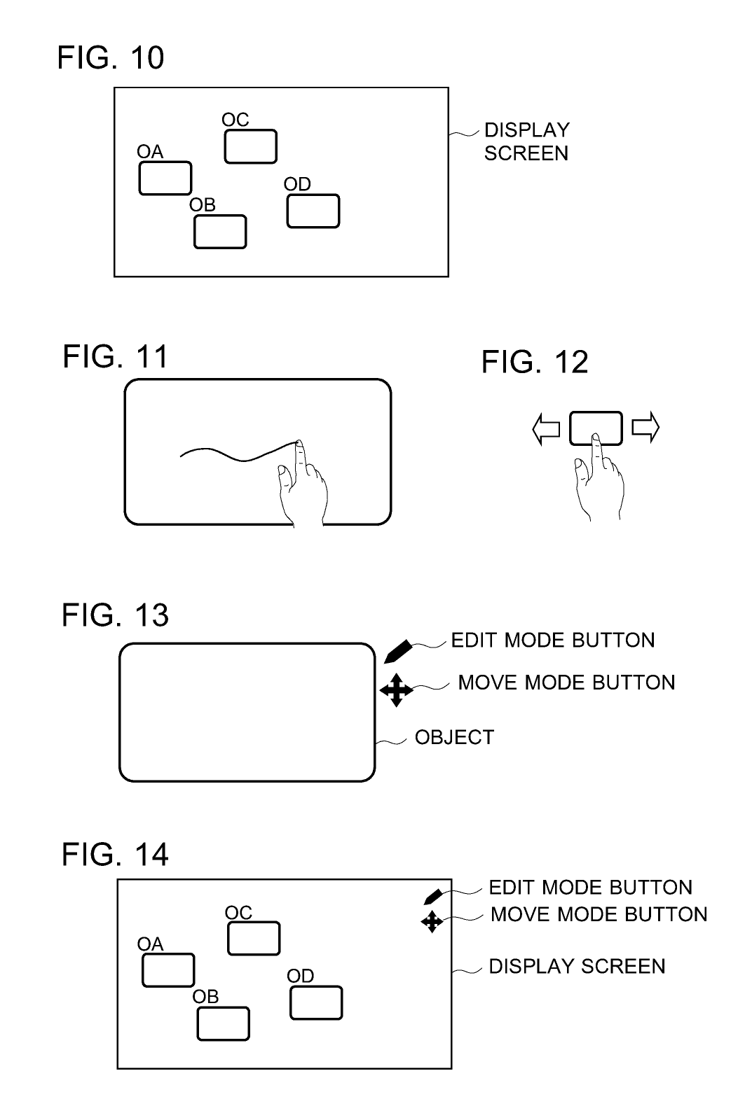

First, control section 20 (operation control section 20d) defines an operation performed by a user on the basis of signals output from operation section 50 (S201). For example, under the condition that objects OA to OD are displayed on display screen of display section 40, as illustrated in FIG. 10 (in this figure, each object is represented by a rectangle), if a user touches one of the objects with the user's finger and performs an operation to move the finger unsteadily as illustrated in FIG. 11, control section 20 (operation control section 20d) defines that the operation is an operation related to editing. On the other hand, if a user touches one of the objects with the user's finger and performs an operation to move the finger linearly, or an operation to swipe or flick the object as illustrated in FIG. 12, control section 20 (operation control section 20d) defines that the operation is an operation related to arrangement. The control section 20 (operation control section 20d) can define the kind of operation by sampling a touch position on the touch screen for short time from the time when a pen (or finger) is put down on the touch screen, and checking the sampling result with patterns which have been stored in advance. Accordingly, the control section 20 can define the kind of operation in response to a user's operation, which do not need user's designation about the kind of operation before the user performs operations. Therefore, the system can offer excellent operability.

Next, control section 20 (operation control section 20d) determines whether the user's operation is an operation related to editing (S202). If the operation is an operation related to editing, control section 20 (operation control section 20d) determines whether the control section 20 (determining section 20c) has determined to prevent an operation related to editing in the process of S106 described above (S203). In other words, control section 20 (operation control section 20d) confirms whether the flag indicating the prevention of an editing operation has been established. Then, if the user's operation is an operation related to editing (YES in S202) and the operation related to editing is not prevented (NO in S203), control section 20 (operation control section 20d) performs the processing of the operation related to editing (S204). If the user's operation is not an operation related to editing (NO in S202), control section 20 (operation control section 20d) performs the processing of the operation related to arrangement (S205). If the user's operation is an operation related to editing (YES in S202) and the operation related to editing is prevented (YES in S203), control section 20 (operation control section 20d) ignores the operation related to editing, and ends the processing. Herein, the control section 20 (operation control section 20d) may prevent operations related to editing performed on all the operated objects, but alternatively, the control section 20 (operation control section 20d) may prevent an operation related to editing performed on at least an object of display size being greater than threshold A among the objects. For example, if the operated object is greater in display size than threshold A, the flow may go to S204 and the control section 20 (operation control section 20d) may perform the processing of the operation related to editing.

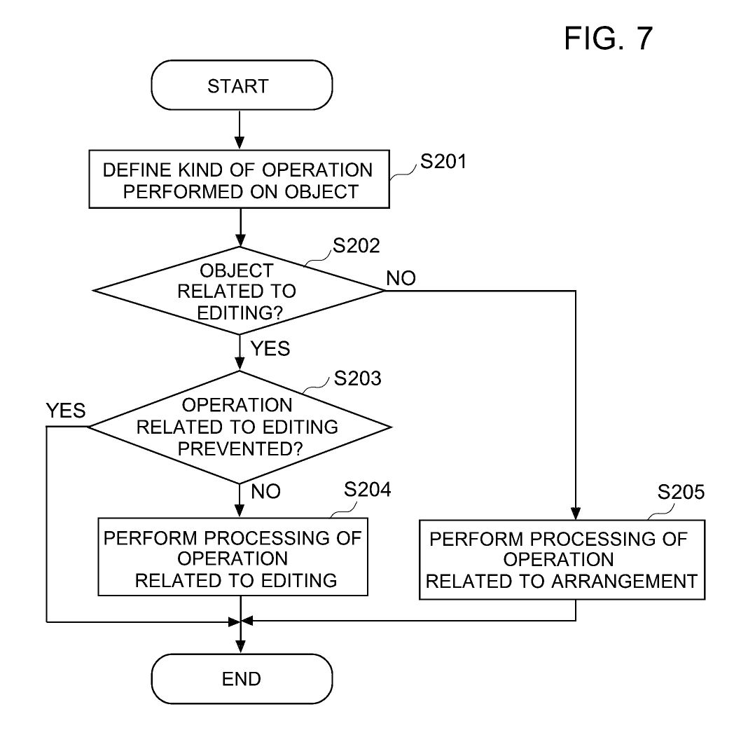

A concrete description is given to an object operation control method based on the flowcharts of FIGS. 6 and 7. In the following description, a user's operation performed on an object is assumed to be an operation related to editing or an operation related to arrangement.

In the present example, for the purpose of clearly indicating operations which can be performed on an object, the system is configured to display on the display screen on display section 40 two operation mode buttons in response to a user's touch on each object, as illustrated in FIG. 13, where the first is an operation mode button (in FIG. 13, an edit mode button having a shape of a pen) indicating that an operation related to editing is acceptable, and the second is an operation mode button (in FIG. 13, a move mode button having a shape of crossing arrows) indicating that an operation related to arrangement is acceptable. The way to display the operation mode buttons is not limited to the above description, and the move mode button and the edit mode button may be displayed at predetermined positions on the display screen displaying objects OA to OD, as illustrated in FIG. 14. The display state of the operation mode buttons is changed in response to the determination result of S105 in FIG. 6 and a user's operation.

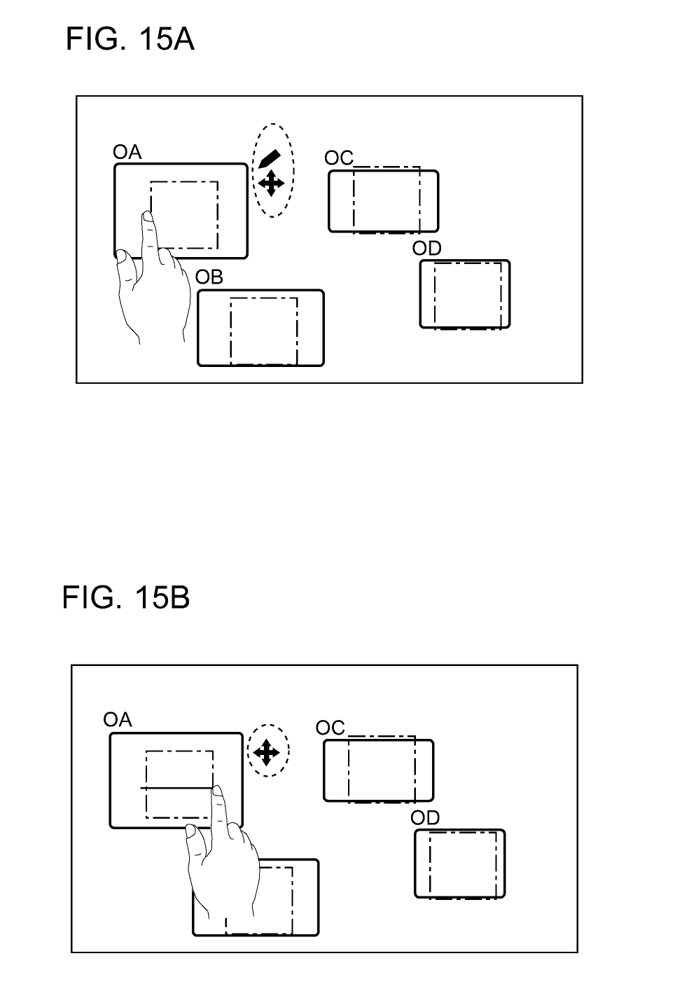

FIGS. 15A and 15B illustrate the display state of the display screen given when a user touches object OA and performs an operation to move the object OA under the condition that the ratio of objects meeting the criterion is greater than threshold B in S105 in FIG. 6 (in these figures, the condition that all the objects OA to OD are greater than threshold A in display size). In FIGS. 15A and 15B and the succeeding figures, a solid line represents an object and a one-dot chain line represents the area of threshold A. In FIGS. 15A and 15B, the relationship of the display sizes of objects OA to OD and the threshold A is represented by the following inequalities:
OA>threshold A,
OB>threshold A,
OC>threshold A, and
OD>threshold A.

Under this condition, since operations related to editing are not prevented, in response to a user's touch onto object OA, the both operation mode buttons of the edit mode button and the move mode button are displayed in an active state (in a valid state) in the vicinity of object OA (see the part of FIG. 15A surrounded by the dashed line). In FIGS. 15A and 15B and the succeeding figures, an operation mode button in the valid state is represented by a button in black. Then, when a user moves the user's finger touching object OA for example linearly, as illustrated in FIG. 15B, operation control section 20d defines that the operation is an operation to move the object, deletes the edit mode button and displays only the move mode button in the vicinity of object OA (see the part of FIG. 15B surrounded by the dashed line).

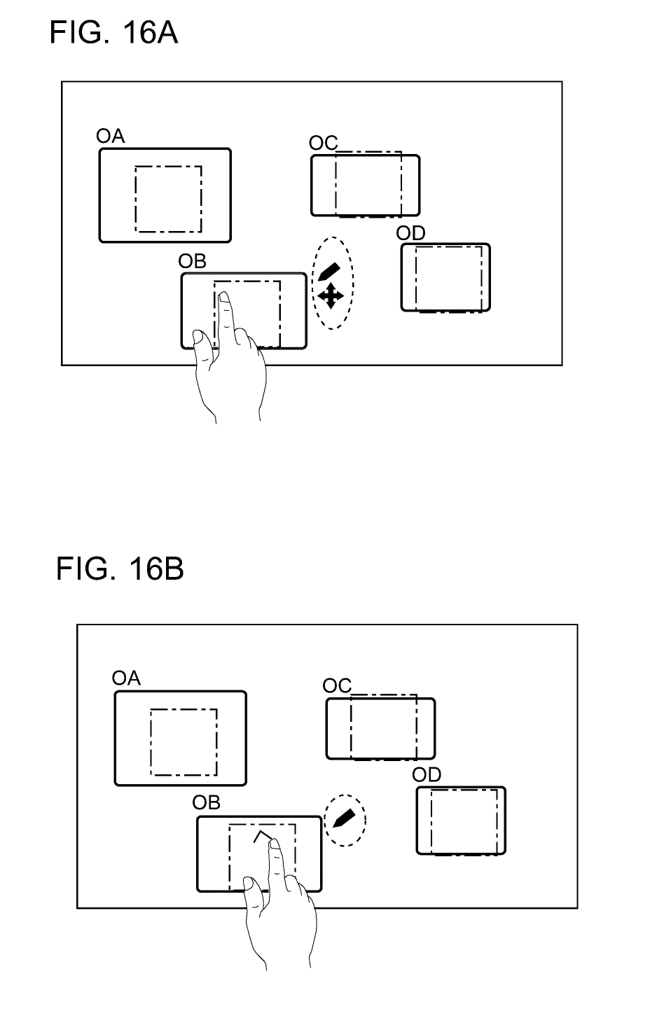

FIGS. 16A and 16B illustrate the display state of the display screen given when a user touches object OB and performs an operation to edit the object OB under the condition that the ratio of objects meeting the criteria is greater than threshold B in S105 in FIG. 6, similarly to FIGS. 15A and 15B. In the display state of FIGS. 16A and 16B, the relationship of the display sizes of objects OA to OD and the threshold A is the same as that of FIGS. 15A and 15B. Also under this condition, since operations related to editing are not prevented, in response to a user's touch onto object OB, the both operation mode buttons of the edit mode button and the move mode button are displayed in an active state (in a valid state) in the vicinity of object OB (see the part of FIG. 16A surrounded by the dashed line). Then, when a user moves the user's finger touching object OB for example unsteadily, as illustrated in FIG. 16B, operation control section 20d defines that the operation is an operation to edit the object, deletes the move mode button and displays only the edit mode button in the vicinity of moved object OB (see the part of FIG. 16B surrounded by the dashed line). Operation control section 20d may keep the edit mode button and the move mode button displayed until a user touches another object and then delete the buttons after the user's touch on another object, or may delete the buttons after a predetermined time period is elapsed.

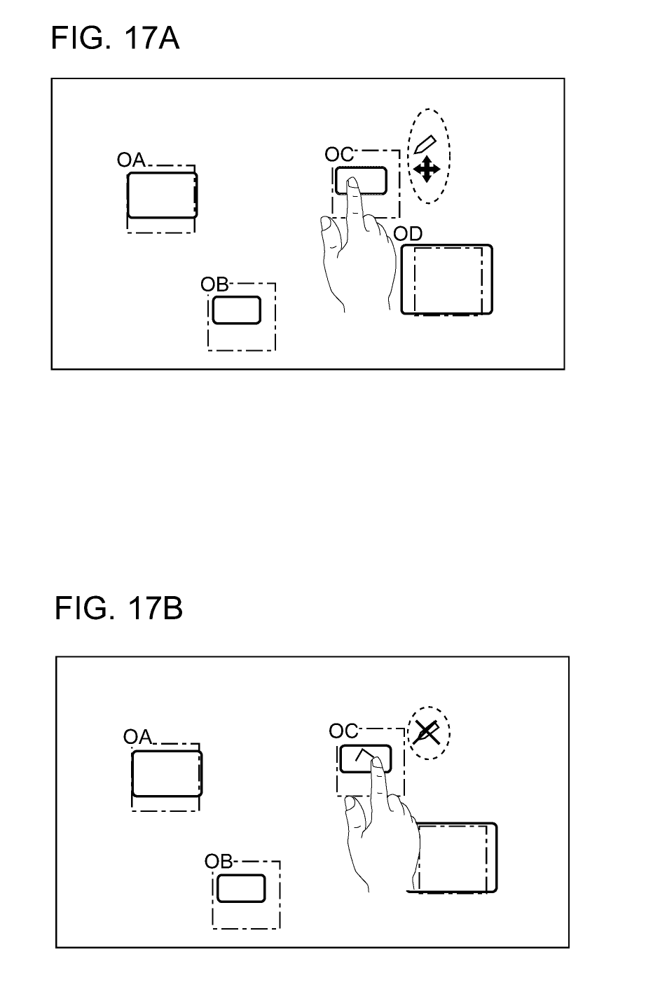

FIGS. 17A and 17B illustrate the display state of the display screen given when a user touches object OC under the condition that the ratio of objects meeting the criterion is not greater than threshold B in S105 in FIG. 6 (in these figures, the condition that objects OA to OC are less than threshold A in display size, and object OD is greater than threshold A in display size). In FIGS. 17A and 17B, the relationship of the display sizes of objects OA to OD and the threshold A and is represented by the following inequalities:
OA<threshold A,
OB<threshold A,
OC<threshold A, and
OD>threshold A.

Under this condition, since operations related to editing are prevented, in response to a user's touch onto object OC, as illustrated in FIG. 17A, the move mode button is displayed in an active state (in a valid state) and the edit mode button is displayed in an inactive state (in an invalid state) with being grayed out in the vicinity of object OC (see the part of FIG. 17A surrounded by the dashed line). In FIGS. 17A and 17B and the succeeding figures, an operation mode button in the invalid state is represented by a button in white.

If a user moves the user's finger touching object OC moves linearly under this condition, similarly to the above condition, operation control section 20d deletes the edit mode button and displays only the move mode button on the display screen. On the other hand, if a user moves the user's finger touching object OC moves for example unsteadily as illustrated in FIG. 17B (for the purpose of easy understanding, the finger trace is represented by a solid line in FIG. 17B, but it should be noted that the trace does not appear on an actual display screen), operation control section 20d defines that the operation is an operation to edit the object, does not set the operation mode to the edit mode, and does not accept the edit operation since an operation related to editing is prevented. In this situation, operation control section 20d may delete the edit mode button in an inactive mode from the display screen, or may conduct another control. For example, operation control section 20d may display on the display screen a cross sign overlapping with the edit mode button (see the part of FIG. 17B surrounded by the dashed line) to inform a user that an operation related to editing is now prevented, or may confirm a user whether to actually process the operation related to editing.

As described above, under the condition that the ratio of objects of display size being greater than threshold A among the objects as operation targets is greater than threshold B, the control section 20 determines that every object has a possibility that a user edits the object, and accepts both of an operation related to arrangement and an operation related to editing. Under another condition that the ratio of objects of display size being greater than threshold A is not greater than threshold B, the control section 20 determines that the probability is low that a user edits the objects and then accepts an operation related to arrangement but prevents an operation related to editing. It allows users who are discussing to operate objects as intended on the system. Further, it prevents an operation which can make an unwanted record from being performed before it happens, which avoids a deterioration of quality of image obtained after the whole discussion. Further, by defining a user's operation and setting the operation mode automatically to display a button corresponding to the operation mode and/or a cross sign overlapped with the edit mode button, user's operability of the system can be enhanced. In FIGS. 17A and 17B, the operation control section 20d prevents an operation related to editing for ant of all the objects as operation targets, but alternatively may prevent an operation related to editing for at least an object or objects of display size being not greater than threshold A among all the objects. That is, the operation control section 20d may accept both of an operation related to arrangement and an operation related to editing, both performed on object OD of which the display size is greater than threshold A. Accordingly, under the condition that there are many objects of small display size, the operation control section 20d prevents an operation related to editing of any of all the small-sized objects, and accepts an operation related to editing of any of objects of greater display size, which provides users a good operability. Under any conditions, the object operation system obtains the sizes of all the objects as operation targets and controls whether to prevent a specific operation on an object in accordance with the ratio of objects of display size exceeding a threshold among all the objects as operation targets. Such a control uses factors of determination including which of objects of greater size and objects of smaller size are major in in the objects as operation targets, which allows users natural operations on the system and hardly makes the users confused during their operations.

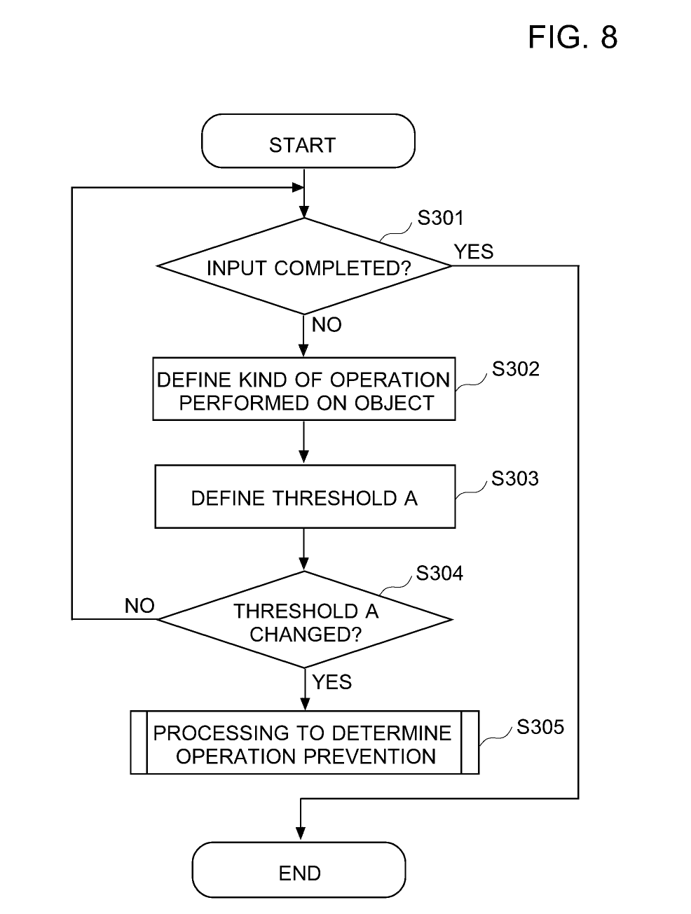

In the flowcharts of FIGS. 6 and 7, operation control section 20d determines whether to prevent an operation performed on an object by using the threshold A defined as a fixed value in advance. Alternatively, operation control section 20d may change the threshold A corresponding to the kind of user's operation. A description is given to operation of object operation system 10 employing such a control with reference to the flowchart of FIG. 8.

First, control section 20 (operation control section 20d) detects an input of a user's operation on the display screen on the basis of signals output from operation section 50, and determines whether the input has been completed (S301). If it is in the middle of the input, control section 20 (operation control section 20d) defines the kind of operation that the user is going to perform, on the basis of conditions of the input (moving locus) from the start of the input (S302). For example, corresponding to any of an operation that a user moves the user's finger unsteadily, an operation that a user moves the user's finger linearly, an operation that a user changes the distance of the user's two fingers, an operation that a user turns the two fingers, control section 20 (operation control section 20d) defines that the input is any of an operation to edit an object, an operation to move an object, an operation to enlarge or reduce an object, and an operation to rotate or flip an object. Then, control section 20 (operation control section 20d) sends information about the kind of operation to determining section 20c.

Next, control section (determining section 20c) defines the value of threshold A according to the kind of operation (S303). For example, as described above, since an operation to edit an object and an operation to enlarge or reduce an object make a change of the display size of the object concerned, control section (determining section 20c) defines the threshold A to be a greater value if an operation to edit an object or an operation to enlarge an object is performed, and defines the threshold A to be a smaller value if an operation to reduce an object is performed. As for the values of threshold A, there is prepared a table stored in a storage such as ROM 22, where the table includes possible values of the threshold A defined with being associated with kinds of operation. By using the table, control section (determining section 20c) can define the value of threshold A.

Next, control section 20 (determining section 20c) determines whether the value of threshold A has changed (S304). If the value of threshold A has not changed, the flow returns to S301, and repeats similar processing until the input is completed. On the other hand, if the value of threshold A has changed, control section 20 (determining section 20c) performs processing to determine operation prevention illustrated in FIG. 6, by using the changed threshold A (S305). When a user performs an operation on the display screen after the processing to determine operation prevention, the control section 20 performs the processing of object operation according to the flowchart of FIG. 7.

As described above, by defining the kind of operation on the basis of information of a finger or pen trace from the start of a user's input, defining the value of threshold A according to the kind of operation, and redoing the processing to determine operation prevention when the value of threshold A changed, the object operation system employing such a control can realize user's operations on objects furthermore reflecting the user's intention.

The above description were given to basic operation of object operation system 10 of the present example. Hereinafter, a description will be given to a modified example of the object operation control of the object operation system 10.

In the examples illustrated in FIGS. 16A and 16B and FIGS. 17A and 17B, the object operation system 10 is configured to allow a user to recognize that an operation related to editing is accepted or prevented by various ways: displaying a mark of a pen in an active state in the vicinity of an object as an operation target, displaying a mark of a pen with being grayed out, and displaying a cross sign on a mark of a pen to overlap with each other. However, the way to inform to a user whether an operation related to editing is accepted or prevented is not especially limited. For example, the following variations can be employed.

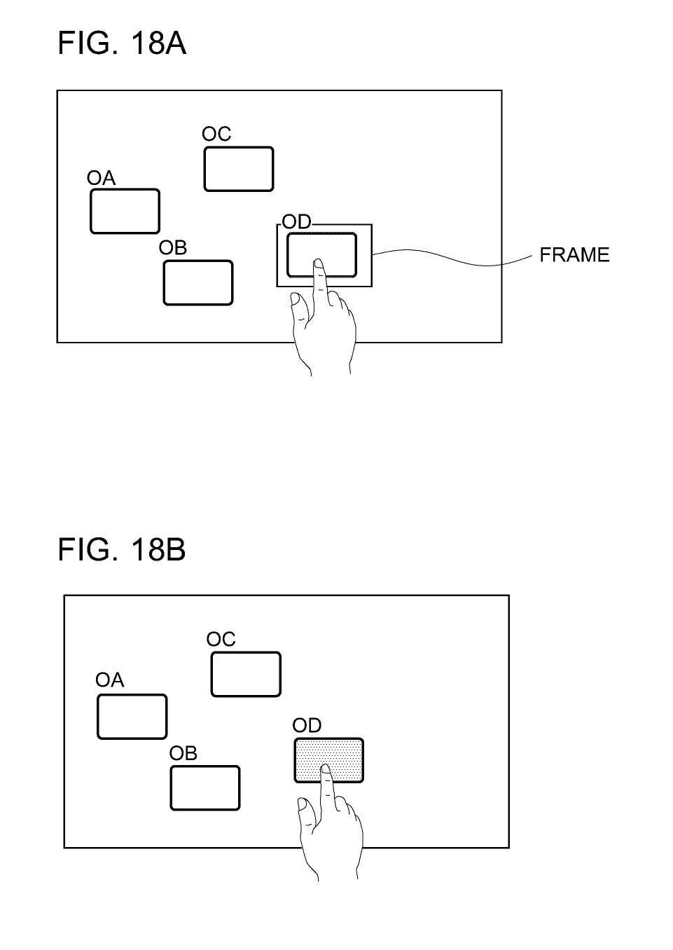

For example, in response to a user's touch on object OD, as illustrated in FIG. 18A, the control section 20 may display a frame surrounding the object on the display screen under the condition that an operation related to editing is accepted, and display no frame surrounding the object under the condition that an operation related to editing is prevented, so as to inform a user whether an operation related to editing is accepted or prevented. Alternatively, in response to a user's touch on object OD, as illustrated in FIG. 18B, the control section 20 may change a display state of the object (for example, by making lines in the object thick, changing the object in color, or making the object blink) under the condition that an operation related to editing is accepted; and keep the display state of the object under the condition that an operation related to editing is prevented, so as to inform a user whether an operation related to editing is an accepted operation or a prevented operation.

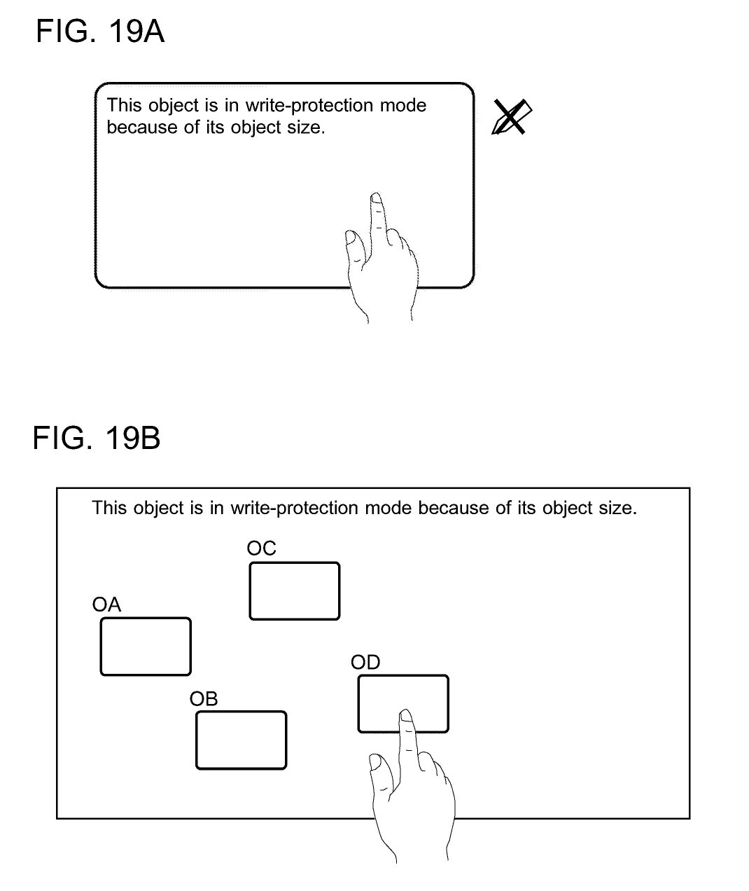

Alternatively, in response to a user's touch on an object as illustrated in FIG. 19A, under the condition that an operation related to editing is prevented, the control section 20 may display a warning message like “This object is in write-protection mode because of its object size” on the display screen to be associated with the touched object so as to inform a user whether an operation related to editing is accepted or prevented. As illustrated in FIG. 19B, in response to a user's touch on an object, under the condition that an operation related to editing is prevented, the control section 20 may display a similar warning message on a predetermined position on the display screen, so as to inform a user whether an operation related to editing is accepted or prevented. In addition to or in place of that, the control section 20 may inform a user the message by using a voice message or an alarm sound through an output unit like a speaker put on object operation system 10.

In the above descriptions, the control section 20 of the object operation system 10 determines whether to prevent an operation related to editing, on the basis of the ratio of objects of greater display size than threshold A. Alternatively, since it can be considered that there is less necessity for an object of very small display size to be edited under the condition that plural objects as operation targets includes an object of very small display size, the control section 20 may prevent an operation related to editing performed on any one of all the objects as operation targets including the object of very small display size. A description is given to operation of object operation system 10 employing such a control with referring to the flowchart of FIG. 9.

First, similarly to the example of FIG. 6, control section 20 (display size calculating section 20b) determines whether calculation of display sizes of plural objects as operation targets (all the objects displayed on display section 40, plural objects displayed in a certain area in display section 40, or plural object grouped in advance) has been completed (S401). If there is an object of which the display size is calculated, control section 20 (display size calculating section 20b) calculates the display size (occupied area, height, or width) of the object on the basis of information of the displayed position of the object sent from display control section 20a (S402).

In the flowchart of FIG. 6, the control section 20 compares the calculated display size of each of the objects and threshold A. In the flowchart of FIG. 9, another threshold (referred to as threshold A2) which is smaller than threshold A is defined in advance, and the control section 20 compares the display size calculated in S402 with the threshold A2 (S403). If the display size is not greater than (equal to or less than) threshold A2, the flow skips to S407, and control section 20 (operation control section 20d) determines an operation or operations to be prevented (operations related to editing, in this example).

If the display size is greater than threshold A2, control section 20 (determining section 20c) compares the calculated display size with threshold A (S404). If the display size is not greater than threshold A, the flow returns to S401 and similar processing is repeated. If the display size is greater than threshold A, control section 20 (determining section 20c) increments the value of the count of objects meeting to the criteria by 1 (S405), and then the flow returns to S401.

Then, if the calculation of display sizes of all the objects as operation targets has been completed (YES in S401), control section 20 (determining section 20c) calculates the ratio of objects meeting the criteria among the objects as operation targets, and determines whether the ratio of objects meeting the criteria is greater than threshold B (S406). If the ratio of objects meeting the criteria is greater than threshold B, the processing ends. If the ratio of objects meeting the criteria in not greater than threshold B, control section 20 (operation control section 20d) determines to prevent an operation to be prevented (an operations related to editing, in this example) (S407).

When a user performs an operation on the display screen after the processing to determine operation prevention, the control section 20 performs the processing of object operation according to the flowchart of FIG. 7.

With such a control, if the ratio of the objects meeting the criteria is greater than threshold A and there is no object being greater in display size than threshold A2 in the plural objects as operation targets, the control section 20 accepts an operation related to arrangement and an operation related to editing, both performed on any of the plural of objects as operation target. Further, if at least one of the plural objects is not greater in display size than threshold A2, the control section 20 accepts an operation related to arrangement performed on any of the plural of objects, and prevents an operation related to editing performed on any of the plural of objects.

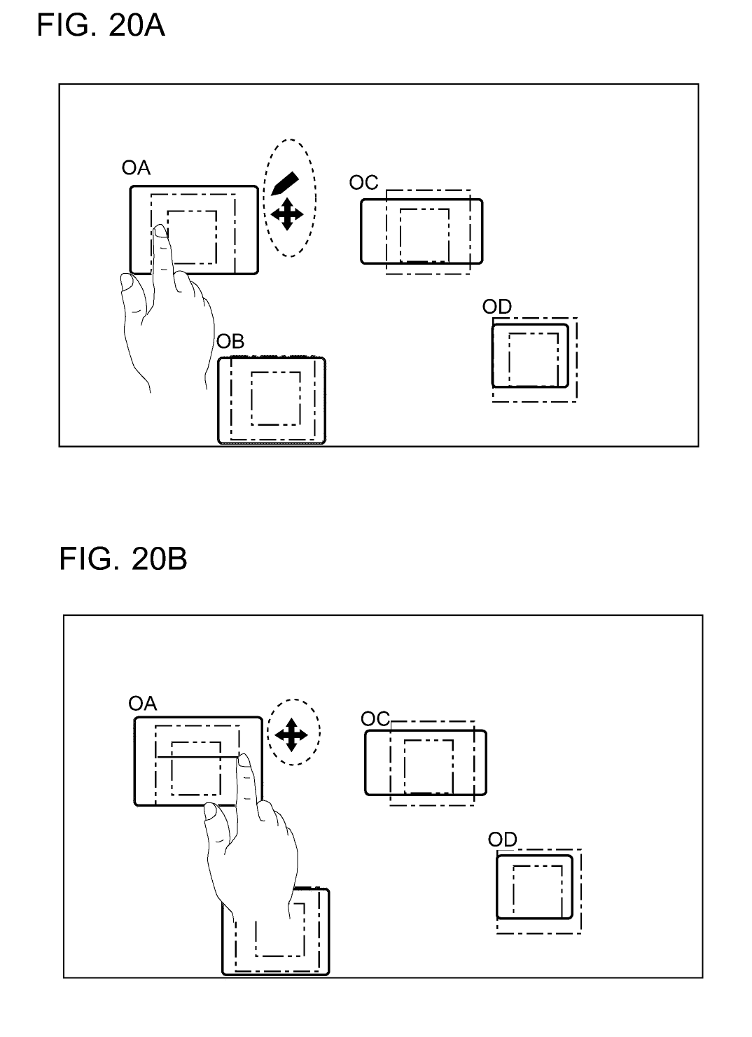

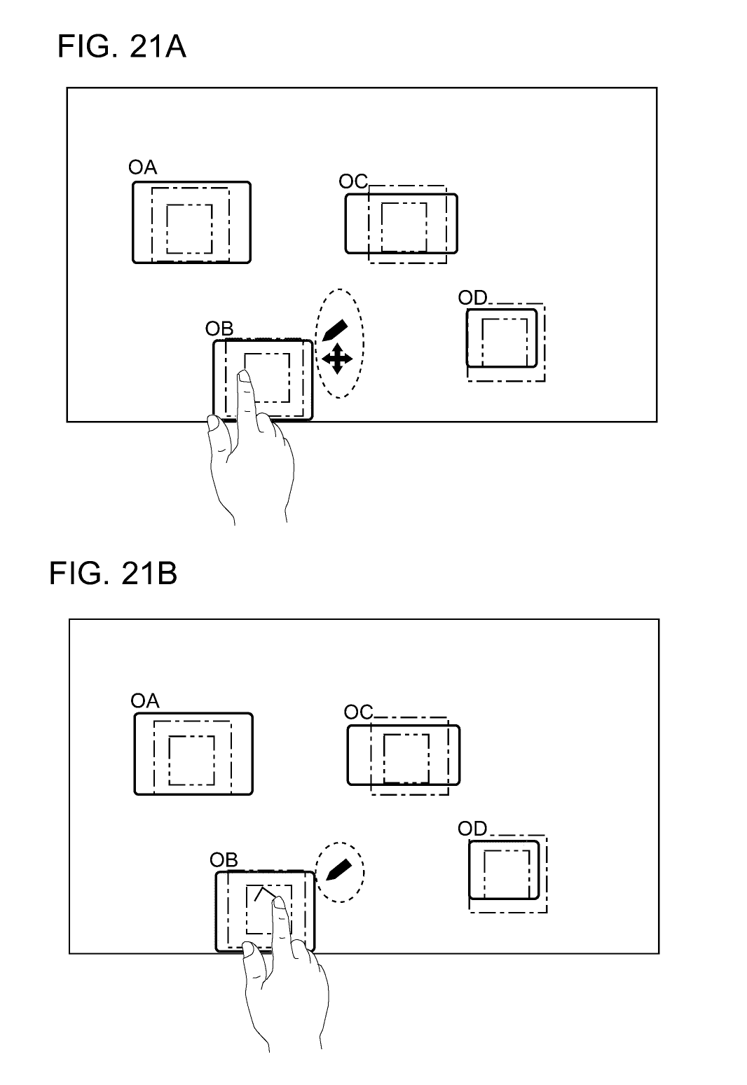

A concrete description is given to the object operation control based on the flowchart of FIG. 9, with reference to FIGS. 20A and 20B, FIGS. 21A and 21B, and FIGS. 22A and 22B. FIGS. 20A and 20B and FIGS. 21A and 21B illustrate the display states of the display screen when a user touches an object under the condition that the display sizes of all the objects OA to OD are greater than threshold A2 in S403 in the flowchart of FIG. 9 and the ratio of objects meeting the criteria is greater than threshold B in S409 in the flowchart of FIG. 9, where the relationship of the display sizes of objects OA to OD and the thresholds A and A2 is represented by the following inequalities:
OA>threshold A>threshold A2,
OB>threshold A>threshold A2,
threshold A>OC>threshold A2, and
threshold A>OD>threshold A2.

Under this condition, since operations related to editing are not prevented, the control section 20 displays on the display screen the both operation mode buttons of an edit mode button and a move mode button in an active state (in an valid state) in the vicinity of the touched object OA as illustrated in FIGS. 20A and 21A (see the part surrounded by the dashed line in in FIGS. 20A and 21A). Further, the control section 20 displays on the display screen only one of the operation mode buttons (the edit mode button and the move mode button) corresponding to a user's operation performed on an object, as illustrated in FIGS. 20B and 21B, that is, only the move mode button is displayed in FIG. 20B and only the edit mode button is displayed in FIG. 21B (see the parts surrounded by the dashed line in FIGS. 20B and 21B).

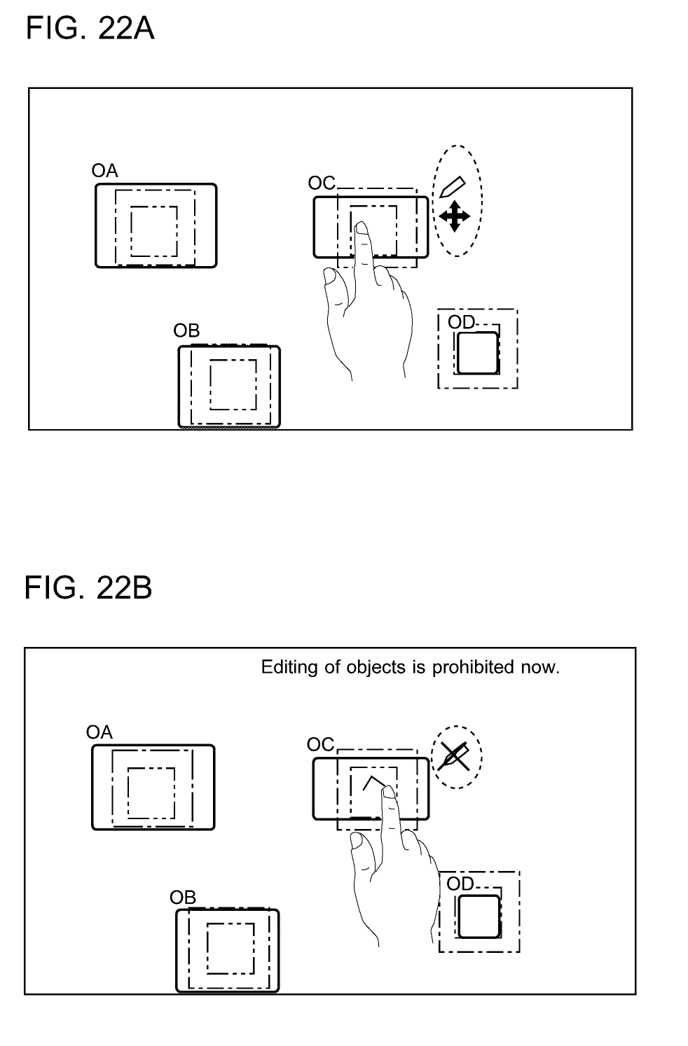

FIGS. 22A and 22B illustrate the display state of the display screen when a user touches one (object OC) of objects OA to OD under the condition that the display size of any one (object OD in this example) of the objects OA to OD is less than threshold A2 in S403 in the flowchart of FIG. 9, where the relationship of the display sizes of objects OA to OD and the thresholds A and A2 is represented by the following inequalities:
OA>threshold A>threshold A2,
OB>threshold A>threshold A2,
threshold A>OC>threshold A2, and
threshold A>threshold A2>OD.

Under this condition, since operations related to editing are prevented, the control section 20 displays on the display screen a move mode button in an active state (in a valid state) and an edit mode button in an inactive state (in an invalid state) with being grayed out in the vicinity of the touched object OC (see the part of FIG. 22A surrounded by the dashed line), as illustrated in FIG. 22A. If a user further performs a move operation on the touched object OC, the control section 20 displays on the display screen only the move mode button, similarly to the above-described case. On the other hand, if a user further performs an edit operation on the touched object OC, as illustrated in FIG. 22B, the control section 20 does not accept the edit operation and displays on the display screen a cross sign with overlapping with the edit mode button (see the part of FIG. 22B surrounded by the dashed line), to inform a user that that an operation related to editing is currently prevented. Additionally, in the example of FIG. 22B, the control section 20 further displays on the display screen an message to indicate that operations related to editing of every object as operation targets are prevented.

In the example of FIGS. 22A and 22B, the control section 20 prevents an operation related to editing of any of the object as operation targets, under the condition that at least one of the plural objects is not greater in display size than threshold A2. However, the control section 20 may prevent an operation related to editing of at least an object of display size being not greater than threshold A among all the object as operation targets, under the condition that at least one of the plural objects is not greater in display size than threshold A2.

Similarly to the object operation control based on the flowchart of FIG. 7, the control section 20 may define a kind of an operation performed on an object displayed on the display screen, and if at least one of the plural objects as operation targets is not greater in display size than threshold A2 and the kind of operation is an operation related to editing of an object, the control section 20 may prevent the operation related to editing of the object.

As described above, by employing threshold A2 which is smaller than threshold A into the object operation control, the object operation apparatus can avoid a trouble that an operation related to editing is accepted for an object of very small display size and can allow users to realize performing operations on objects as intended. In the control, the control section 20 may accept an operation related to both of arrangement and editing for an object of display size being greater than threshold A, which makes the object operation apparatus user-friendly.

Incidentally, the present invention should not be limited to the above-mentioned embodiments and examples and unless deviating from the intention of the present invention, the constitution of the object operation system and the object operation control method may be changed appropriately.

For example, in the above-described examples, possible operations to be performed on objects are classified into operations related to editing and operations related to arrangement. However, the operations may be classified into different operation groups or into an increased number of operation groups. Further, in the above-described examples, operations related to editing and operations related to arrangement were given as examples of the possible operations to be performed on objects. However, other operations can be employed for the possible operations to be performed on objects in an arbitrary manner, and the above-described control may be applied similarly to operations to rotate, flip, enlarge, reduce, create, delete, and deform an object.

Further, in the above-described examples, the ratio of objects of greater display size than the threshold was given as an example of the statistic information obtained on the basis of the display sizes of the objects. However, the statistic information is not limited to the ratio, and the similar effect can be obtained also by using any one of the average of the display sizes, the standard deviation of the display sizes, the difference of the maximum and the minimum of the display sizes, as the statistic information.

Further, in the above-described examples, the control section of the object operation system defines the kind of operation automatically. However, the way to define of the kind of operation is not limited to that, and the control section may allow a user to select the kind of operation through operation section 50.

The embodiments and examples of the present invention are applicable to an object operation system which controls whether to accept or prevent user's operations on plural objects, a non-transitory computer-readable storage medium storing an object operation control program for causing an apparatus to perform the control, and an object operation control method for use in such a system.

Although embodiments and examples of the present invention has been described and illustrated in detail, it is clearly understood that the same is by way of illustrated and example only and is not to be taken by way of limitation, the scope of the present invention being interpreted by terms of the appended claims.

1. An object operation system comprising:
a display section which can display objects thereon;
an operation section which allows a user to operate an object displayed on the display section; and
a control section which controls the display section and the operation section,
wherein the control section
calculates display sizes of a plurality of objects displayed on the display section as operation targets,
calculates statistic information about the display sizes,
determines whether the statistic information meets a criterion defined in advance, and
on determining that the statistic information does not meet the criterion, prevents a specific operation performed through the operation section on at least one of the plurality of objects.

2. The object operation system of claim 1,
wherein the control section
calculates a ratio of objects of display size being greater than a first threshold defined in advance, among the plurality of objects,
determines whether the ratio is greater than a second threshold defined in advance, and
on determining that the ratio is not greater than the second threshold, prevents the specific operation performed through the operation section on at least an object of display size being not greater than the first threshold among the plurality of objects.

3. The object operation system of claim 2,
wherein the control section defines the first threshold in accordance with a kind of operation performed on an object displayed on the display section.

4. The object operation system of claim 2,
wherein the control section
further determines whether the display size of each of the plurality of objects is greater than a third threshold defined in advance, and
on determining that at least one of the plurality of objects is not greater in display size than the third threshold, prevents the specific operation performed through the operation section on at least the object of display size being not greater than the first threshold among the plurality of objects.

5. The object operation system of claim 2,
wherein, on determining that the ratio is greater than the second threshold, the control section
accepts an operation related to arrangement performed on an object among the plurality of objects and an operation related to editing performed on an object among the plurality of objects, and
wherein, on determining that the ratio is not greater than the second threshold, the control section
accepts an operation related to arrangement performed on an object among the plurality of objects, and
prevents an operation related to editing performed on at least the object of display size being not greater than the first threshold among the plurality of objects.

6. The object operation system of claim 5,
wherein the control section
defines a kind of an operation performed on an object displayed on the display section, and
on determining that the ratio is not greater than the second threshold and the kind of operation is an operation related to editing of an object, prevents the operation related to editing of the object.

7. The object operation system of claim 6,
wherein the control section informs a user whether the operation performed on the object is an accepted operation or a prevented operation so that a user can distinguish the accepted operation and the prevented operation.

8. The object operation system of claim 6,
wherein on defining the operation performed on the object as an operation related to editing of the object and preventing the operation related to editing of the object, the control section informs a user that the operation is prevented.

9. The object operation system of claim 5,
wherein the operation related to editing of an object is an operation to modify components of the object.

10. The object operation system of claim 5,
wherein the operation related to arrangement of an object is one of an operation to move the object, an operation to rotate the object, an operation to flip the object, an operation to enlarge the object and an operation to reduce the object.

11. The object operation system of claim 4,
wherein, on determining that the ratio is greater than the second threshold and there is no object being greater in display size than the third threshold in the plurality of objects, the control section
accepts an operation related to arrangement performed on an object among the plurality of objects and an operation related to editing performed on an object among the plurality of objects, and
wherein, on determining that at least one of the plurality of objects is not greater in display size than the third threshold, the control section
accepts an operation related to arrangement performed on an object among the plurality of objects, and
prevents an operation related to editing of at least the object of display size being not greater than the first threshold among the plurality of objects.

12. The object operation system of claim 11,
wherein the control section
defines a kind of an operation performed on an object displayed on the display section, and
on determining that at least one of the plurality of objects is not greater in display size than the third threshold and the kind of operation is an operation related to editing of an object, prevents the operation related to editing of the object.

13. The object operation system of claim 12,
wherein the control section informs a user whether the operation performed on the object is an accepted operation or a prevented operation so that a user can distinguish the accepted operation and the prevented operation.

14. The object operation system of claim 12,
wherein on defining the operation performed on the object as an operation related to editing of the object and preventing the operation related to editing of the object, the control section informs a user that the operation is prevented.

15. The object operation system of claim 11,
wherein the operation related to editing of an object is an operation to modify components of the object.

16. The object operation system of claim 11,
wherein the operation related to arrangement of an object is one of an operation to move the object, an operation to rotate the object, an operation to flip the object, an operation to enlarge the object and an operation to reduce the object.

17. The object operation system of claim 1,
wherein the display sizes of the plurality of objects are one of areas of the plurality of objects, heights of the plurality of objects, and widths of the plurality of objects.

18. A non-transitory computer-readable storage medium storing an object operation control program to be executed in an apparatus which controls a display section which can display objects thereon and an operation section which allows a user to operate an object displayed on the display section, the object operation control program, when being executed by a processor of the apparatus, causing the apparatus to perform processing comprising:
calculating display sizes of a plurality of objects displayed on the display section;
calculating statistic information about the display sizes;
determining whether the statistic information meets a criterion defined in advance; and
on determining that the statistic information does not meet the criterion, preventing a specific operation performed through the operation section on at least one of the plurality of objects.

19. The non-transitory computer-readable storage medium of claim 18,
wherein the calculating the statistic information includes calculating a ratio of objects of display size being greater than a first threshold defined in advance, among the plurality of objects,
the determining whether the statistic information meets the criterion includes determining whether the ratio is greater than a second threshold defined in advance, and
the preventing the specific operation includes, on determining that the ratio is not greater than the second threshold, preventing the specific operation performed through the operation section on at least an object of display size being not greater than the first threshold among the plurality of objects.

20. An object operation control method for use in a system including a display section which can display objects thereon and an operation section which allows a user to operate an object displayed on the display section, the method comprising:
calculating display sizes of a plurality of objects displayed on the display section;
calculating statistic information about the display sizes;
determining whether the statistic information meets a criterion defined in advance; and
on determining that the statistic information does not meet the criterion, preventing a specific operation performed through the operation section on at least one of the plurality of objects.

21. The object operation control method of claim 20,
wherein the calculating the statistic information includes calculating a ratio of objects of display size being greater than a first threshold defined in advance, among the plurality of objects,
the determining whether the statistic information meets the criterion includes determining whether the ratio is greater than a second threshold defined in advance, and
the preventing the specific operation includes, on determining that the ratio is not greater than the second threshold, preventing the specific operation performed through the operation section on at least an object of display size being not greater than the first threshold among the plurality of objects.
